(19) United States
(12) Patent Application Publication
(10) Pub. No.: US 2011/0126970 A1
(43) Pub. Date: Jun. 2, 2011

(54) METALLIC LAMINATE AND MANUFACTURING METHOD OF CORE SUBSTRATE USING THE SAME

(75) Inventors: Sang-Youp LEE, Seoul (KR); Joung-Gul Ryu, Seoul (KR); Dong-Sun Kim, Suwon-si (KR); Jae-Hoon Choi, Yongin-si (KR); In-Ho Seo, Suwon-si (KR); Joon-Sung Lee, Seoul (KR)

(73) Assignee: SAMSUNG ELECTRO-MECHANICS CO., LTD.

(21) Appl. No.: 12/773,325

(22) Filed: May 4, 2010

(30) Foreign Application Priority Data
Dec. 1, 2009 (KR) 10-2009-0117791

(51) Int. Cl. B32B 38/10; B32B 15/04; B32B 15/00

(52) U.S. Cl. 156/233; 428/621

(57) ABSTRACT

A metallic laminate and a method of manufacturing a core substrate using the same are disclosed. In accordance with an embodiment of the present invention, the metallic laminate includes an insulation material, a carrier layer, which is stacked on both surfaces of the insulation layer and in which the carrier layer is a metal, and a first metal foil, which is stacked on one surface of the carrier layer. By symmetrically forming two core substrates on either surface above and below the insulation material, each process of forming the core substrate can be performed at the same time in the shape of a pair of facing core substrates, thereby increasing the productivity by twice. The remaining insulation material having the carrier layer stacked thereon can be used as a base substrate that is used to manufacture a printed circuit board, thus preventing unnecessary waste of the insulation material.

### CROSS-REFERENCE TO RELATED APPLICATIONS

This application claims the benefit of Korean Patent Application No. 10-2009-0117791, filed with the Korean Intellectual Property Office on Dec. 1, 2009, the disclosure of which is incorporated herein by reference in its entirety.

### BACKGROUND

1. Technical Field

The present invention is related to a metallic laminate and a method of manufacturing a core substrate using the metallic laminate.

2. Description of the Related Art

In step with the trends toward smaller, higher density and thinner electronic components, studies are underway to develop a thinner semiconductor package substrate with higher functionalities. Particularly, in order to implement a multi-chip packages (MCP) technology, in which a plurality of semiconductor chips are stacked on one substrate, or a package on package (POP) technology, in which a plurality of substrates having chips embedded therein are stacked on one another, it is needed to develop a board that has a thermal expansion behavior that is similar to that of a chip and has excellent warpage properties after the chip is embedded.

With the recent trend toward higher-performance chips, the increase in operating speed of the chip causes a heating problem. Consequently, finding a solution to this problem is desperately needed.

In the conventional copper foil laminate, a thin copper foil of 2 to 3 um is stacked on the upper and lower surfaces of an insulation material, for example, prepreg. The conventional copper foil laminate is used by being severed into a designed size according to the purpose. Because of the thin copper foil of 2 to 3 um, it is difficult to handle the thin copper foil and thus impossible to directly stack the copper foil on the insulation material. In response to this problem, the copper foil is stacked on a carrier layer to stack the copper foil on the insulation material. Also, since the copper foil has to be readily separated from the insulation material and the copper foil laminate has to withstand high temperatures above 200° C., a separation film having good thermal endurance is interposed between the insulation material and the copper foil. The use of the expensive separation film may increase the production cost. In order to separate the carrier layer and the copper foil from each other, a release layer can be interposed between the carrier layer and the copper foil.

### SUMMARY

The present invention provides a metallic laminate and a method of manufacturing a core substrate using the metallic laminate that is not necessary to use an expensive separation film and can recycle an insulation material that is discarded after being used to manufacture the core substrate.

An aspect of the present invention provides a metallic laminate that includes an insulation material, a carrier layer, which is stacked on both surfaces of the insulation layer and in which the carrier layer is a metal, and a first metal foil, which is stacked on one surface of the carrier layer.

The carrier layer and the first metal foil can include copper.

Another aspect of the present invention provides a method of manufacturing a core substrate that includes preparing a metallic laminate, in which the metallic laminate includes an insulation material, a metallic carrier layer stacked on both surfaces of the insulation material and a first metal foil stacked on one surface of the carrier layer, stacking a first insulation material on the first metal foil, stacking a metal sheet on the first insulation material, stacking a second insulation material on the metal sheet so as to cover the metal sheet, stacking a second metal foil on the second insulation material, and separating the carrier layer and the first metal foil from each other.

The preparing of the metallic laminate can include pressing the first metal foil such that the carrier layer is adhered to the insulation material.

The carrier layer, the first metal foil and the second metal foil can include copper.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 shows a metallic laminate in accordance with an embodiment of the present invention.

FIG. 2 is a flow diagram illustrating a method of manufacturing a core substrate in accordance with an embodiment of the present invention.

FIGS. 3 to 7 show a method of manufacturing a core substrate in accordance with an embodiment of the present invention.

### DETAILED DESCRIPTION

As the invention allows for various changes and numerous embodiments, a particular embodiment will be illustrated in the drawings and described in detail in the written description. However, this is not intended to limit the present invention to a particular mode of practice, and it is to be appreciated that all changes, equivalents, and substitutes that do not depart from the spirit and technical scope of the present invention are encompassed in the present invention. In the description of the present invention, certain detailed descriptions of related art are omitted when it is deemed that they may unnecessarily obscure the essence of the invention.

While such terms as “first” and “second,” etc., may be used to describe various components, such components must not be limited to the above terms. The above terms are used only to distinguish one component from another.

The terms used in the present specification are merely used to describe a particular embodiment, and are not intended to limit the present invention. An expression used in the singular encompasses the expression of the plural, unless it has a clearly different meaning in the context. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

A metallic laminate and a method of manufacturing a core substrate using the metallic laminate according to a certain embodiment of the present invention will be described below in more detail with reference to the accompanying drawings. Those components that are the same or are in correspondence are rendered the same reference numeral regardless of the figure number, and redundant descriptions are omitted.

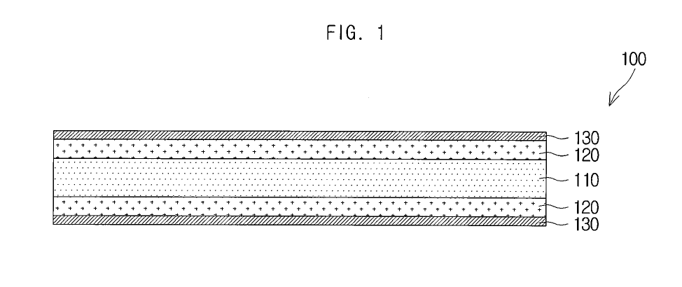

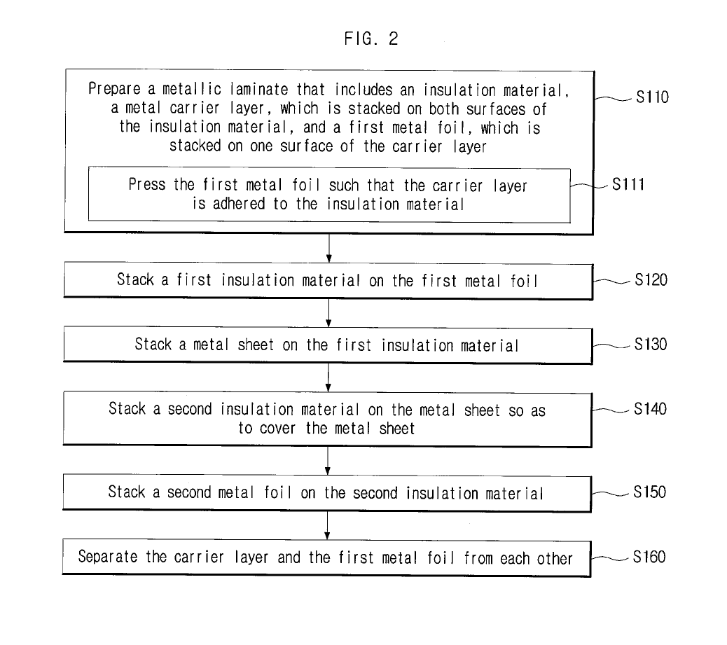

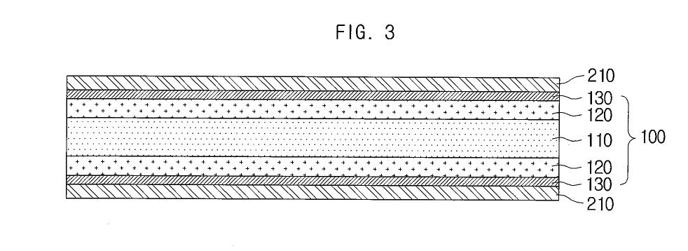

FIG. 1 shows a metallic laminate in accordance with an embodiment of the present invention, and FIG. 2 is a flow diagram illustrating a method of manufacturing a core substrate in accordance with an embodiment of the present invention. FIGS. 3 to 7 show a method of manufacturing a core substrate in accordance with an embodiment of the present invention.

First, a metallic laminate 100 is prepared (S110). The metallic laminate 100 includes an insulation material 110, a metal carrier layer 120, which is stacked on both surfaces of the insulation material 110, and a first metal foil 130, which is stacked on one surface of the carrier layer 120.

A typical metallic laminate uses, for example, a separation film in order to separate a metal foil from an insulation material because the metal foil is directly stacked on the insulation material, increasing the production cost. In the manufacturing method of a core substrate of the present embodiment, however, the first metal foil 130 can be pressed such that the carrier layer 120 is adhered to the insulation material 110 (S111) in order to prepare the metallic laminate (S110). Since this process does not separate the carrier layer 120 from the insulation material 110, no additional material, for example, a separation film, is required so that the manufacturing cost can be saved. Before pressing the first metal foil 130, a vacuum press (not shown) can be preheated in response to the curing temperature of the insulation material 110.

Illustrated in FIG. 1 is the metallic laminate 100, which includes the insulation material 110, the metal carrier layer 120, stacked on both surfaces of the insulation material 110, and the first metal foil 130, stacked on one surface of the carrier layer 120.

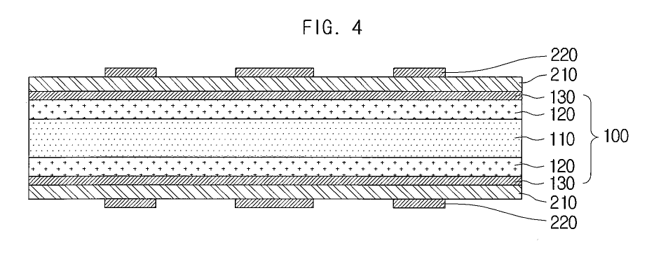

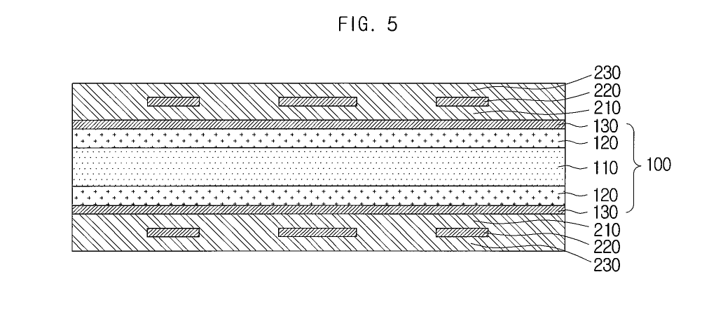

As illustrated in FIG. 3, a first insulation material 210 is stacked on the first metal foil 130 of the metallic laminate 100 that is formed through the above processes (S120). Then, as illustrated in FIG. 4, a metal sheet 220 is stacked on the first insulation material 210 (S130). Next, as illustrated in FIG. 5, a second insulation material 230 is stacked on the metal sheet 220 so as to cover the metal sheet 220 (S140). Since the metal sheet 220 is made of a metallic material that has higher thermal conductivity than, for example, insulation resin, the metal sheet 220 can not only efficiently dissipate heat generated by the operation of a printed circuit board to be formed but also prevent the warpage of a core substrate 200. In one example, the metal sheet 220 can include copper (Cu) or aluminum (Al).

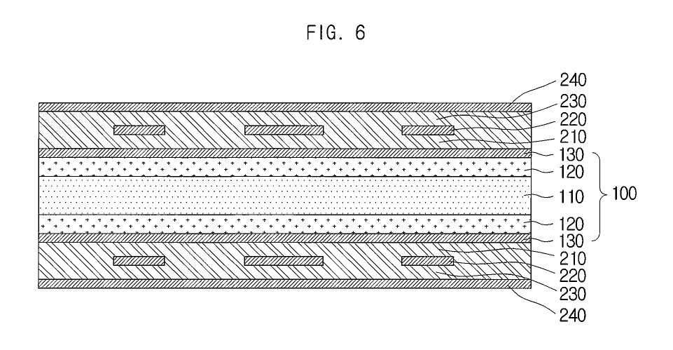

Next, a second metal foil 240 is stacked on the second insulation material 230 (S150). Here, the carrier layer 120, the first metal foil 130 and the second metal foil 240 can include copper. Through these processes, two core substrates 200 are formed on either surface above and below the insulation material 110, as illustrated in FIG. 6. By performing the same processes together at the same time on the upper and lower surfaces of the insulation material 110, the productivity can be increased by twice. Although it is not illustrated in the drawings, it is also possible that, after a release layer and a carrier layer are successively stacked on the second metal foil 240, the second metal foil 240 can be stacked in such a way that the second metal foil 240 is in contact with the second insulation material 230. After stacking the second metal foil 240, the carrier layer can be readily removed by the release layer.

Next, the carrier layer 120 and the first metal foil 130 are separated from each other (S160). In one example, separation of the first metal foil 130 can be readily performed by interposing a release layer between the carrier layer 120 and the first metal foil 130.

As described above, by symmetrically forming two core substrates 200 on either surface above and below the insulation material 110, each process of forming the core substrate 200 can be performed at the same time in the shape of a pair of facing core substrates 200, thereby increasing the productivity by twice.

Furthermore, after the core substrate 200 is separated from the insulation material 110, the remaining insulation material 110 having the carrier layer 120 stacked thereon can be used as a base substrate that is used to manufacture a printed circuit board, thus preventing unnecessary waste of the insulation material 110 and recycling the resource.

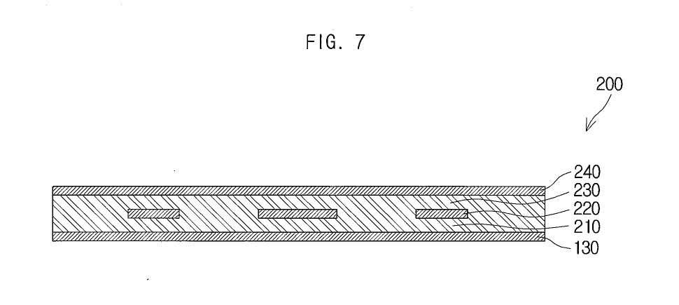

Illustrated in FIG. 7 is the core substrate 200. By forming a circuit pattern (not shown) and a pad (not shown) on the surface of the core substrate 200, a printed circuit board can be manufactured. The pad functions as a terminal that is connected to an external component, for example, a semiconductor chip or a mother board, by exposing a portion of the circuit pattern formed on the surface of the core substrate 200.

While the spirit of the present invention has been described in detail with reference to a particular embodiment, the embodiment is for illustrative purposes only and shall not limit the present invention. It is to be appreciated that those skilled in the art can change or modify the embodiment without departing from the scope and spirit of the present invention.

As such, many embodiments other than that set forth above can be found in the appended claims.

What is claimed is:

1. A metallic laminate comprising:
an insulation material;
a carrier layer stacked on both surfaces of the insulation layer, the carrier layer being a metal; and
a first metal foil stacked on one surface of the carrier layer.

2. The metallic laminate of claim 1, wherein the carrier layer and the first metal foil comprise copper.

3. A method of manufacturing a core substrate, the method comprising:
preparing a metallic laminate, the metallic laminate comprising an insulation material, a metallic carrier layer stacked on both surfaces of the insulation material, and a first metal foil stacked on one surface of the carrier layer;
stacking a first insulation material on the first metal foil;
stacking a metal sheet on the first insulation material;
stacking a second insulation material on the metal sheet so as to cover the metal sheet;
stacking a second metal foil on the second insulation material; and
separating the carrier layer and the first metal foil from each other.

4. The method of claim 3, wherein the preparing of the metallic laminate comprises pressing the first metal foil such that the carrier layer is adhered to the insulation material.

5. The method of claim 3 or 4, wherein the carrier layer, the first metal foil and the second metal foil comprise copper.
